(19) United States
(12) Patent Application Publication
(10) Pub. No.: US 2016/0138937 A1
(43) Pub. Date: May 19, 2016

(54) ELECTRONIC DEVICE AND GRAVITY SENSING CALIBRATION METHOD THEREOF

(71) Applicant: Wistron Corporation, New Taipei City (TW)

(72) Inventor: Yan-Mei Zhai, New Taipei City (TW)

(21) Appl. No.: 14/637,399

(22) Filed: Mar. 4, 2015

(30) Foreign Application Priority Data
Nov. 14, 2014 (CN) 201410649715.X

(51) Int. Cl. G01C 25/00; G06F 3/01; H04N 5/232

(52) U.S. Cl. CPC G01C 25/00; H04N 5/23229; G06F 3/017

(57) ABSTRACT

An electronic device and a gravity sensing calibration method thereof are provided. The electronic device includes a gravity sensing unit, an image capturing unit and a processing unit. The gravity sensing unit recognizes a rotating direction of the electronic device according to default gravity reference data. The image capturing unit captures an image with an object. The processing unit obtains a current gravity sensing value through the gravity sensing unit and generates specific gravity reference data according to the current gravity sensing value. The processing unit analyzes the image to determine a moving direction of the object relative to the electronic device, so as to recognize the rotating direction of the electronic device according to the specific gravity reference data and the moving direction of the object.

### CROSS-REFERENCE TO RELATED APPLICATION

This application claims the priority benefit of China application serial no. 201410649715.X, filed on Nov. 14, 2014. The entirety of the above-mentioned patent application is hereby incorporated by reference herein and made a part of this specification.

### BACKGROUND

1. Field of the Invention

The invention is directed to a calibrating technique of an electronic device and more particularly to an electronic device and a gravity sensing calibration method thereof.

2. Description of Related Art

At present, many consumer electronic products are equipped with gravity sensors (e.g., gyroscopes, accelerometers or the like) for detecting in which angle or direction the electronic products are placed. Thereby, an application in an electronic product (e.g., a mobile phone, a tablet computer or the like) can perform a corresponding somatosensory or gravity sensing type operation. The gravity sensing type operation can be applied in an application for playing music, photographing photo or video, stabilization calibration, or somatosensory games, for example. However, currently, reference data of the gravity sensor is calibrated only before the electronic product is designed and manufactured, such that a user cannot re-calibrate the reference data of the gravity sensor in any other way after acquiring the electronic product.

Thus, when the user uses the electronic product in a regular posture, such as sitting or standing for the gravity sensing type operation, the electronic product can be normally operated. However, when the user lies down or is in another posture (e.g., standing upside down or lying on one side), neither standing nor sitting, the user may not operate the electronic product for the gravity sensing type operation as he/she expects due to the gravity sensor incapable of being adaptively adjusted.

Therefore, how to allow the user in different postures can adaptively use the electronic product to successfully perform the gravity sensing type operation becomes one technology for the manufacturers to develop.

### SUMMARY

The invention provides an electronic device and a gravity sensing calibration method thereof which allows a user in an irregular posture (e.g., lying on one side, standing upside down and lying down) to successfully use the electronic device for a gravity sensing type operation.

According to an aspect of the invention, an electronic device including a gravity sensing unit, an image capturing unit and a processing unit is provided. The gravity sensing unit is configured to recognize a rotating direction of the electronic device according to default gravity reference data. The image capturing unit is configured to capture an image with an object. The processing unit is coupled with the gravity sensing unit and the image capturing unit. The processing unit is configured to obtain a current gravity sensing value through the gravity sensing unit and generate specific gravity reference data according to the current gravity sensing value and. The processing unit is configured to analyze the image to determine a moving direction of the object relative to the electronic device, so as to recognize the rotating direction of the electronic device according to the specific gravity reference data and the moving direction of the object.

In an embodiment of the invention, when receiving a gravity sensing calibration request, the processing unit obtains the current gravity sensing value through the gravity sensing unit and generates the specific gravity reference data according to the current gravity sensing value.

In an embodiment of the invention, the processing unit transmits a value of the rotating direction recognized and obtained according to the specific gravity reference data to an application executed by the electronic device.

In an embodiment of the invention, the image capturing unit is a front lens module of the electronic device.

In an embodiment of the invention, the object is a user's face.

According to another aspect of the invention, a gravity sensing calibration method of an electronic device is provided. The electronic device includes a gravity sensing unit and an image capturing unit. The gravity sensing calibration method includes the following steps: obtaining a current gravity sensing value through the gravity sensing unit; generating specific gravity reference data according to the current gravity sensing value; capturing an image with an object by the image capturing unit and analyzing the image to determine a moving direction of the object relative to the electronic device; and recognizing the rotating direction of the electronic device according to the specific gravity reference data and the moving direction of the object.

In an embodiment of the invention, the gravity sensing calibration method further includes the following steps: determining whether a gravity sensing calibration request is received; and when the gravity sensing calibration request is received, obtaining the current gravity sensing value by the gravity sensing unit and generating the specific gravity reference data according to the current gravity sensing value.

In an embodiment of the invention, the gravity sensing calibration method further includes the following steps: transmitting a value of the rotating direction recognized and obtained according to the specific gravity reference data to an application executed by the electronic device.

To sum up, the electronic device provided by the embodiments of the invention can calibrate the gravity reference data thereof according to the current gravity sensing value sensed by the gravity sensing unit, such that the electronic device can adaptively adjust gravity sensing unit according to a posture of the user when holding the electronic device. Thereby, the electronic device can obtain the rotating direction of the electronic device according to the calibrated gravity reference data, the currently sensed gravity and the moving direction of a target object (e.g., a user's face) relative to the electronic device sensed by the front lens module. In this way, when the user uses the electronic device in an irregular posture (e.g., lying on one side, standing upside down and lying down), the electronic device still can successfully perform the gravity sensing type operation by means of setting the gravity sensing calibration.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating an electronic device according to an embodiment of the invention.

FIG. 2 is a flowchart illustrating a gravity sensing calibration method of an electronic device according to an embodiment of the invention.

FIG. 3 is a schematic diagram illustrating the setting of the gravity sensing calibration according to an embodiment of the invention.

FIG. 4 is a schematic diagram illustrating the electronic device placed on a planar surface in a static state.

FIG. 5 is a schematic diagram illustrating a user holding the electronic device in a lying down posture.

FIG. 6 and FIG. 7 are schematic diagrams illustrating the electronic device and objects according to an embodiment of the invention.

### DESCRIPTION OF EMBODIMENTS

Currently, when an electronic device involves with a gravity sensing type operation, the electronic device typically utilizes a gravity sensing unit (e.g., an accelerometer, a gyroscope or the like) to read corresponding values on three default coordinate axes (i.e., the X, the Y and the Z axes) and recognize a moving direction or a rotating direction of the electronic device according to changes of the corresponding value on the three default coordinate axes. However, in a scenario that a user lying down or lying on one side performs the gravity sensing type operation of the electronic device, values sensed by the gravity sensing unit are not the same as the default values when the electronic device is manufactured, and changes in positive and negative numbers may occur to the values for the gravity sensing type operation, which lead the electronic device to be unexpectedly operated as the user originally wishes. Accordingly, in the embodiments of the invention, by means of re-calibrating gravity reference data of a gravity sensing unit in the electronic device and determining a moving direction of a target object (e.g., the user′ face) relative to the electronic device through a front lens module of the electronic device, the user even in an irregular posture (e.g., lying on one side, standing upside down and lying down) still can use the electronic device successfully for the gravity sensing type operation. Several embodiments of the invention are provided hereinafter to demonstrate the spirit of the invention.

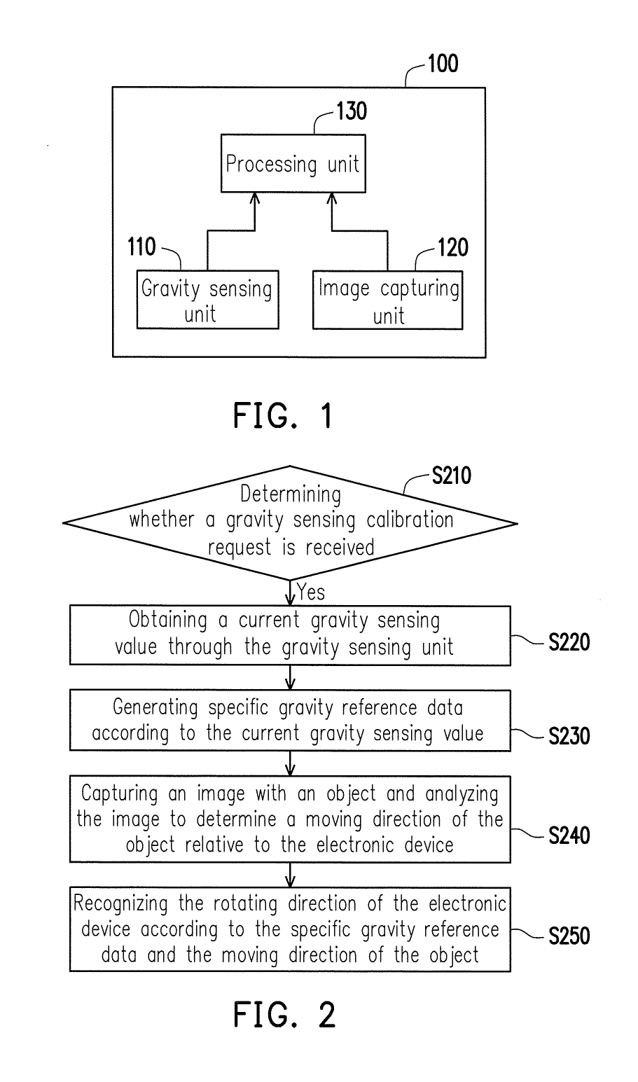

FIG. 1 is a block diagram illustrating an electronic device 100 according to an embodiment of the invention. The electronic device 100 includes a gravity sensing unit 110, an image capturing unit 120 and a processing unit 130. The electronic device 100 may be a currently available consumer electronics product, such as a mobile phone, a tablet computer, an ultra-thin notebook computer. A person who would like to apply the present embodiment may apply the spirit of the invention to any other electronic device as if the electronic device includes the gravity sensing unit 110, the image capturing unit 120 and the processing unit 130.

The gravity sensing unit 110 may be an accelerometer (e.g., a G sensor chip named BMA2X2) or a gyroscope. Before the electronic device 100 is manufactured, the gravity sensing unit 110 is provided with default gravity reference data for recognizing a rotating direction of the electronic device. The image capturing unit 120 may be a front lens module of the electronic device 100 for capturing an image in front of a display of the electronic device 100. In part of the embodiments, the image capturing unit 120 may also be a rear lens module of the electronic device 100, and the person who would like to apply the present embodiment may adjust a direction for capturing the image for the image capturing unit 120 according to the spirit of the invention.

The processing unit 130 is coupled to the gravity sensing unit 110 and the image capturing unit 120, respectively. In the present embodiment, the processing unit 130 may be one or a combination of a central processing unit (CPU), a digital signal processor (DSP), a programmable logic device (PLD), an image processor, a complex programmable logic device (CPLD), a field programmable gate array (FPGA) of the electronic device 100. For example, the electronic device 100 may be equipped with a CPU and an image processor specially configured for image processing. Since the image captured by the image capturing unit 120 is processed by the image processor in advance, the processing unit 130 in this circumstance may be a combination of the CPU and the image processor. The person who would like to apply the present embodiment may adaptively serve a combination of the aforementioned elements as the processing unit 130 referred in the invention according to requirements on the electronic device 100.

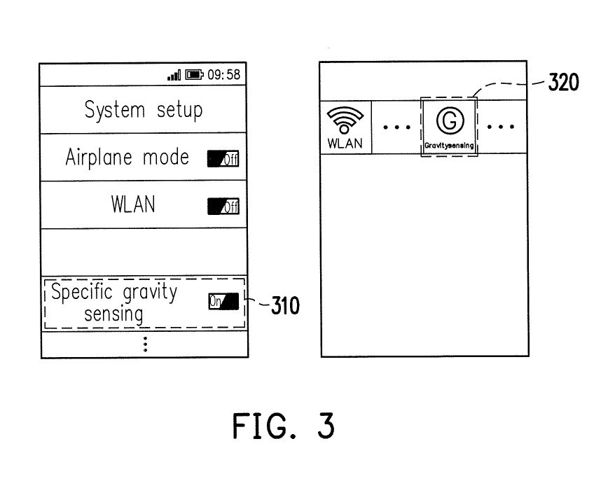

FIG. 2 is a flowchart illustrating a gravity sensing calibration method of the electronic device 100 according to an embodiment of the invention. In the gravity sensing calibration method, the electronic device 100 at least includes the gravity sensing unit 110 and the image capturing unit 120. With reference to FIG. 1 and FIG. 2 simultaneously, in step S210, the electronic device 100 determines whether a gravity sensing calibration request. In the present embodiment, the electronic device 100 may add a setting of the gravity sensing calibration into fields for setting an operation system (OS) thereof, such that a user may send the gravity sensing calibration request through a user interface in the OS. FIG. 3 is a schematic diagram illustrating the setting of the gravity sensing calibration according to an embodiment of the invention. Referring to FIG. 3, the “System setup” user interface illustrated on the left of FIG. 3 may also include a “Specific gravity sensing” setting 310 in addition to the original “Airplane mode” setting and “WLAN” (wireless local area network) setting. The user may enable or disable the “Specific gravity sensing” setting 310 through a button configured thereon. In the “Quick setup” user interface illustrated on the right of FIG. 3, a “Specific gravity sensing” may be added, and the user may enable or disable the “Specific gravity sensing” setting 320 by tapping/clicking thereon. As the function starts, the electronic device 100 may receive the gravity sensing calibration request.

Returning to FIG. 1 and FIG. 2, when receiving the gravity sensing calibration request, the electronic device 100 enters to step S220 from step S210, and the processing unit 130 in the electronic device 100 obtains a current gravity sensing value through the gravity sensing unit 110. In step S230, the processing unit 130 generates specific gravity reference data according to the current gravity sensing value. In the present embodiment, the gravity sensing unit 110 then may recognize a rotating direction of the electronic device 100 according to the specific gravity reference data. In other embodiments, the processing unit 130 may also serve the specific gravity reference data as a calibration basis and use the specific gravity reference data in replacement with the original default gravity reference data in the gravity sensing unit 110. When the gravity sensing calibration request is ended, or the “Specific gravity sensing” setting is set as disabled, the processing unit 130 then reset the gravity sensing unit 110 according to the original default gravity reference data. The person would like to apply the present embodiment may determine whether to re-calibrate the original default gravity reference data in the gravity sensing unit 110 as desired.

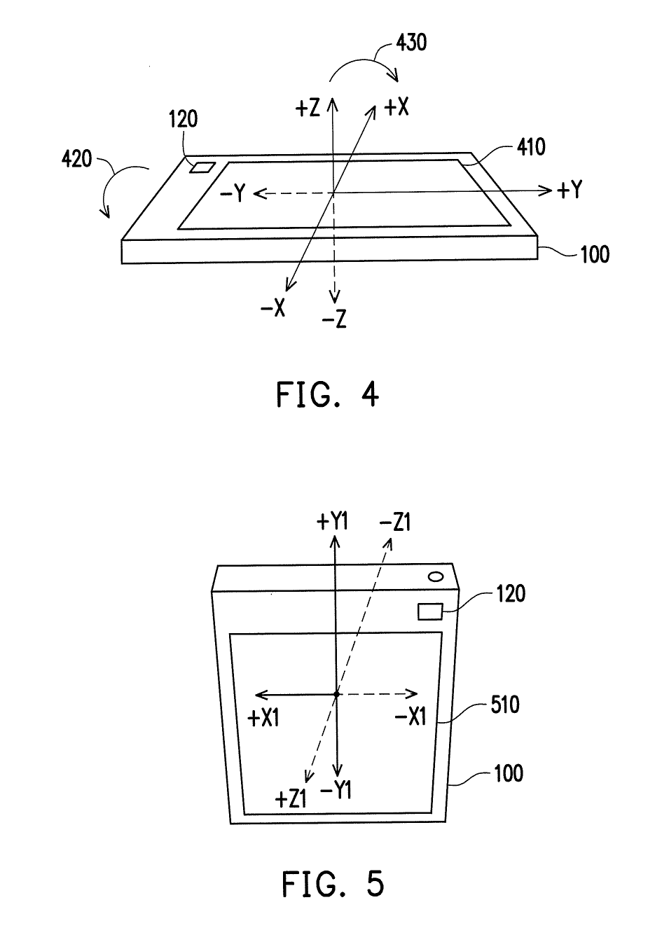

Step S220 and step S230 will be described in detail by using relative gravity sensing data. Generally, before the electronic device 100 is manufactured, the gravity sensing unit 110 is already provided with the default gravity reference data for recognizing the rotating direction of the electronic device. FIG. 4 is a schematic diagram illustrating the electronic device placed on a planar surface in a static state. A gravity sensing value sensed by the gravity sensing unit in the electronic device 100 illustrated in FIG. 4 may be represented as optimal default gravity reference data. The default gravity reference data may be represented in Table (1) as below.

TABLE (1)

| Coordinate direction | X | Y | Z |
|---|---|---|---|
| Default gravity reference data | 0 | 0 | 9.8 |

In FIG. 4, an X, a Y and a Z directions are used for representing an original coordinate of the electronic device 100. The display 410 and the front lens module 120 of the electronic device 100 are arranged toward a positive Z (+Z) direction. In case the gravity sensing unit 110 of the electronic device 100 is to be calibrated, the electronic device 100 commonly has to be horizontally placed, such that the display 410 is configured upward or downward for re-calibrating the gravity sensing unit 110. The “Re-calibrate gravity sensing unit” function is used only in a scenario that the uses experiences inaccuracy occurring to the gravity sensing value of the electronic device 100, and the electronic device 100 has to be static for a long time without being shaken during the re-calibration. If the user wants to change his/her posture, he/she has to re-calibrate the electronic device 100 and re-perform the aforementioned steps, which spends more time. Thus, the “Re-calibrate gravity sensing unit” function is incapable of performing the calibration in case the user is in an irregular posture.

In the present embodiment, a G sensor chip named BMA2X2 is illustrated as an example, in which a maximum and a minimum among the X, the Y and the Z direction values are +9.8 and −9.8, respectively. When the mobile phone is rotated toward the left of the display 410, i.e., rotated around an arrow direction 420 with the Y direction as an axis, the value of the Y direction remains, the value of the X direction is gradually increased from 0 to +9.8, gradually decreased to −9.8 and then again increased to 0, the value of the Z direction is gradually decreased from 9.8 to −9.8 and then increased to +9.8. On other hand, when the mobile phone is rotated toward the top of the display 410, i.e., rotated around an arrow direction 430 with the X direction as an axis, the value of the X direction remains, the value of the Y direction is gradually decreased from 0 to −9.8, gradually increased to +9.8 and then again decreased to 0, the value of the Z direction is gradually decreased from 9.8 to −9.8 and then increased to +9.8.

FIG. 5 is a schematic diagram illustrating a user holding the electronic device 100 in a lying down posture. In FIG. 5, a display 510 of the electronic device 100 faces in a direction (i.e., the +Z direction) toward the face of the user in a lying down posture. In this way, “generating the specific gravity reference data according to the current gravity sensing value” as in referred to step S230 indicates that a new calibrated three-dimensional (3D) coordinate may be formed by a direction that the display 510 faces to (i.e., the +Z1 direction), a direction indicated by a long edge of the display 510 (i.e., a Y1 direction) and a direction indicated by a long edge of the display 510 (i.e., an X1 direction) in the electronic device 100 according to the current gravity sensing value, as shown in FIG. 5. In detail, referring to FIG. 5, if the current gravity sensing value obtained by the electronic device 100 with the X, the Y and the Z directions serving as an original 3D coordinate in step S220 is presented in Table (2), the specific gravity reference data is generated according to the current gravity sensing value, so as to generate the new calibrated 3D coordinate.

TABLE (2)

| Original 3D coordinate | X | Y | X |
|---|---|---|---|
| current gravity sensing value | 2.645 | 7.281 | −5.750 |
| Calibrated 3D coordinate | X1 | Y1 | Z1 |
| Calibrated gravity sensing value | 0 | 0 | 9.8 |

In this way, the electronic device 100 may obtain an absolute value of the rotating direction of the electronic device according to the calibrated 3D coordinate fondled by combining the X1, the Y1 and the Z1 directions, such that the user even in the irregular posture may normally use the gravity sensing type operation of the electronic device 100. However, in step S220 and step S230, only the absolute value of the rotating direction of the electronic device between two 3D coordinates can be obtained, instead of the direction which the rotating direction of the electronic device 100 points to.

Referring again to FIG. 1 and FIG. 2, in step S240, the processing unit 130 captures an image including an object by means of the image capturing unit 120 and analyzes the image to determine a moving direction of the object relative to the electronic device 100. Thereby, the direction which the rotating direction of the electronic device 100 points to may be obtained according to the moving direction of the object relative to the electronic device 100.

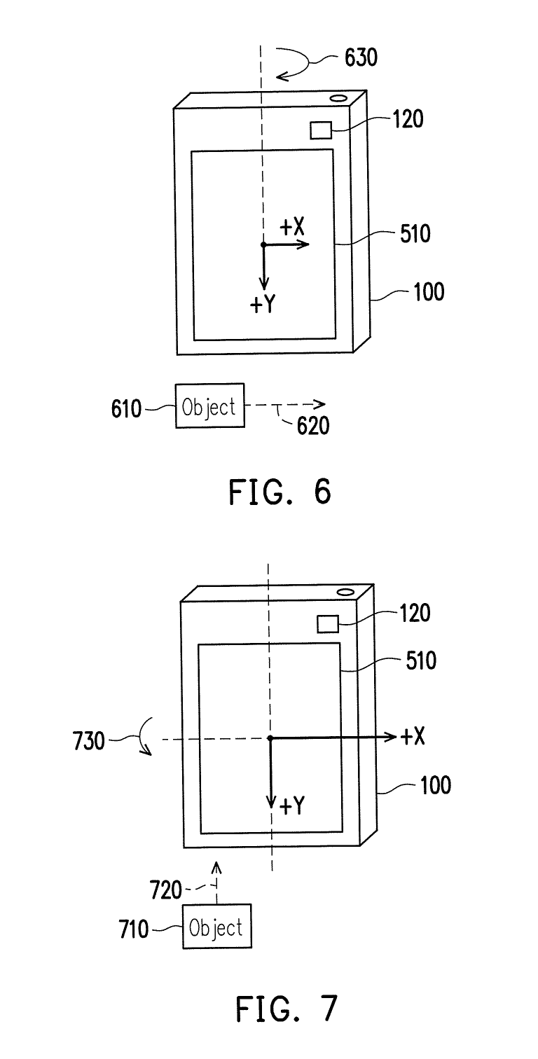

FIG. 6 and FIG. 7 are schematic diagrams illustrating the electronic device 100 and objects 610 and 710 according to an embodiment of the invention. Herein, step S240 of FIG. 2 will be described in detail with reference to FIG. 1, FIG. 6 and FIG. 7. In the present embodiment, both an object 610 of FIG. 6 and an object 710 of FIG. 7 are located in front of the display 510 of the electronic device 100. Positions of the objects 610 and 710 may be obtained by the image capturing unit 120 of the electronic device 100 when capturing the image. Since the electronic device 100 is held by the user, the objects 610 and 710 in this case usually refer to the user's face. The person would like to apply the present embodiment may also serve other objects as the objects 610 and 710. In the present embodiment, the user's face has a characteristic with specific structural distribution, such that a face position and a moving direction of the face relative to the electronic device may be easily recognized by means of a face detection technique and image processing computation. In detail, the processing unit 130 may analyze shapes of face parts, such as the eyes, the nose and the mouth of the object 610 or 710 in the image and geometry configuration relationship among the parts to determine the size and position of the face. After the face is recognized, a skin color primitive may be selected by using face pattern samples in the image so as to establish a Gaussian model with respect to skin chrominance of the face, such that the processing unit 130 may obtain a substantial contour of the face according to the Gaussian model. Thereafter, the processing unit 130 may remove non-face area from the image to obtain face area and thereby, record a coordinate of the center position of the face. Then, the processing unit 130 again perform the aforementioned operation on the next image, such that whether the center position of the face moves may be determined, and in this way, so as to obtain a moving direction of the face.

In part of the embodiments, in case no face is captured in the image by the image capturing unit 120 (i.e., the front lens module) of the electronic device 100, a position of an object with an obvious geometric shape/color in the image may be served as the object 610 or 710, such that the processing unit 130 may recognize the moving direction of the object 610 or 710 relative to the electronic device 100 through analyzing the object with the obvious geometric shape/color in each image.

Since the user operates the electronic device 100 for the gravity sensing operation, the objects 610 and 710 illustrated in FIG. 6 and FIG. 7 may not actually move, and a moving direction (represented by a dotted arrow 620 or 720) of the object 610 or 710 detected by the electronic device 100 is actually formed by the rotation or movement of the electronic device 100 itself. For example, when the electronic device 100 detects that the object 610 of FIG. 6 moves toward the moving direction 620 (i.e., the electronic device 100 detects that the object 610 moves toward the right of the electronic device 100), it indicates that the electronic device 100 is actually rotated toward an arrow direction 630 with the Xdirection as the axis. In contrast, when the electronic device 100 detects that the object 710 of FIG. 7 moves toward the moving direction 720 (i.e., the electronic device 100 detects that the object 710 moves toward the top of the electronic device 100), it indicates that the electronic device 100 is actually rotated toward an arrow direction 730 with the Y direction as the axis. In this way, the electronic device 100 may determine the rotating direction thereof according to the moving direction of the object 610 or 710.

Referring again to FIG. 1 and FIG. 2, in step S250, the processing unit 130 may recognize the rotating direction of the electronic device 100 according to the specific gravity reference data and the moving direction of the object. The processing unit 130 may transmit the rotating direction recognized and obtained according to the specific gravity reference data to an application executed in the electronic device 100, so as to perform a corresponding gravity sensing type operation.

For example, in step S250, when the user deflects the electronic device 100, the current gravity sensing values read by the gravity sensing unit 110 using the original 3D coordinate is shown in Table (3) below.

TABLE (3)

| Original 3D coordinate | X | Y | Z |
|---|---|---|---|
| Current gravity sensing value | 5.462 | 7.468 | −3.654 |

On the other hand, the processing unit 130 determines that the object in the image moves rightward through the image capturing unit 120, and thus, the processing unit determines that the user deflects the electronic device 100 leftward. Since the user's deflecting the electronic device 100 leftward causes changes to the current gravity sensing values, the gravity sensing values of the calibrated 3D coordinate may be shown in Table (4) below.

TABLE (4)

| | Calibrated 3D coordinate | | |
|---|---|---|---|
| | X1 | Y1 | Z1 |
| Calibrated gravity | 0 + (5.462 − | 0 − (7.468 − | 9.8 − (−3.654 − |
| sensing value | 2.654) = 2.988 | 7.281) = −0.367 | (−5.750)) = 7.704 |

In this way, the application may obtain the gravity sensing values of the Calibrated 3D coordinate, and the gravity sensing values generated in this way may be transmitted to the application, such that the user in an irregular posture (e.g., lying on one side, standing upside down and lying down) is then capable of successfully using the electronic device 100 for the gravity sensing type operation.

To sum up, the setting of the gravity sensing calibration may be added into in the electronic device of the embodiments of the invention. When the user enables the setting of the gravity sensing calibration (i.e., provides the gravity sensing calibration request), the electronic device can calibrate the gravity reference data according to the current gravity sensing value sensed by the gravity sensing unit, such that the electronic device can adaptively adjust the gravity sensing unit according to the posture of the user holding the electronic device. In this way, the electronic device can obtain the rotating direction of the electronic device based on the calibrated gravity reference data, the currently sensed gravity sensing value and the moving direction of the target object (e.g., the user's face) relative to the electronic device sensed by the front lens module. Thereby, when using the electronic device in an irregular posture (e.g., lying on one side, standing upside down and lying down), the user still can use the electronic device for the gravity sensing type operation successfully by means of the setting of the gravity sensing calibration.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An electronic device, comprising:
a gravity sensing unit, recognizing a rotating direction of the electronic device according to default gravity reference data;
an image capturing unit, capturing an image with an object; and
a processing unit, coupled with the gravity sensing unit and the image capturing unit, obtaining a current gravity sensing value through the gravity sensing unit, generating specific gravity reference data according to the current gravity sensing value and analyzing the image to determine a moving direction of the object relative to the electronic device, so as to recognize the rotating direction of the electronic device according to the specific gravity reference data and the moving direction of the object.

2. The electronic device according to claim 1, wherein when receiving a gravity sensing calibration request, the processing unit obtains the current gravity sensing value through the gravity sensing unit and generates the specific gravity reference data according to the current gravity sensing value.

3. The electronic device according to claim 1, wherein the processing unit transmits a value of the rotating direction recognized and obtained according to the specific gravity reference data to an application executed by the electronic device.

4. The electronic device according to claim 1, wherein the image capturing unit is a front lens module of the electronic device.

5. The electronic device according to claim 1, wherein the object is a user's face.

6. A gravity sensing calibration method of an electronic device, the electronic device comprising a gravity sensing unit and an image capturing unit, and the gravity sensing calibration method comprising:
obtaining a current gravity sensing value through the gravity sensing unit;
generating specific gravity reference data according to the current gravity sensing value;
capturing an image with an object by the image capturing unit and analyzing the image to determine a moving direction of the object relative to the electronic device; and
recognizing the rotating direction of the electronic device according to the specific gravity reference data and the moving direction of the object.

7. The gravity sensing calibration method according to claim 6, further comprising:
determining whether a gravity sensing calibration request is received; and
when the gravity sensing calibration request is received, obtaining the current gravity sensing value by the gravity sensing unit and generating the specific gravity reference data according to the current gravity sensing value.

8. The gravity sensing calibration method according to claim 6, further comprising:
transmitting a value of the rotating direction recognized and obtained according to the specific gravity reference data to an application executed by the electronic device.

9. The gravity sensing calibration method according to claim 6, wherein the image capturing unit is a front lens module of the electronic device.

10. The gravity sensing calibration method according to claim 6, wherein the object is a user's face.
